(19) United States
(12) Patent Application Publication
(10) Pub. No.: US 2011/0136606 A1
(43) Pub. Date: Jun. 9, 2011

(54) CHAIN-SPROCKET MECHANISM, CHAIN AND SPROCKET

(75) Inventor: Minetaka ENDO, Saitama (JP)

(73) Assignee: HITACHI METALS TECHNO, LTD., Tokyo (JP)

(21) Appl. No.: 13/026,732

(22) Filed: Feb. 14, 2011

Related U.S. Application Data
(62) Division of application No. 11/614,254, filed on Dec. 21, 2006.

(30) Foreign Application Priority Data
Dec. 26, 2005 (JP) 2005-371875
Jan. 25, 2006 (JP) 2006-016199
Jan. 25, 2006 (JP) 2006-016207

(51) Int. Cl. F16G 13/07

(52) U.S. Cl. 474/207

(57) ABSTRACT

A chain-sprocket mechanism is disclosed which is highly resistant to corrosion caused by a potential difference arising when metallic materials of different types contact each other. A chain of the chain-sprocket mechanism is structured by coupling a plurality of chain links that consist of pairs of outer plates, pairs of inner plates, bushings fixed to the inner plates and pins inserted through the outer plates, the inner plates and the bushing, which meshes with teeth of a sprocket. The surface of either of the bushing or the teeth is formed of a non-metallic material; thereby, a potential difference does not arise through the contact between the bushing and the teeth. Accordingly, corrosion caused by a potential difference can be avoided, i.e., the corrosion resistance of the chain-sprocket mechanism can be improved.

### CROSS REFERENCE TO RELATED APPLICATION

This is a divisional of and claims priority from U.S. patent application Ser. No. 11/614,254 filed Dec. 21, 2006, the content of which is incorporated herein by reference.

### BACKGROUND OF THE INVENTION

1. Field of the Invention

The present invention relates to a chain-sprocket mechanism, a chain and a sprocket.

2. Description of the Related Art

A water treatment apparatus used for city water, sewage, industrial waste water, or the like includes an apparatus called a sludge collector that collects sand, sludge, and the like precipitated on the bottom of a sedimentation basin or a sand settling pond.

A sludge collector normally has plates called flights for collecting sludge, the flights being attached between a pair of chains; as the chains rotate, the flights move on the bottom of a sedimentation basin or a sand settling pond and collect sand, sludge and the like.

The chain is normally structured so that a plurality of outer links and a plurality of inner links are bendably coupled by using pins, and the inner link consists of a pair of inner plates opposing each other and bushings having a through hole, the bushings being fixed to both ends of the inner plates.

The outer link consists of a pair of outer plates opposing each other and pins inserted through the inner plates, the outer plates and the bushings.

There is another type of chain that is structured by using stepped-plates having both an inner plate portion and an outer plate portion in one piece. There is also a case that a rotatable roller is provided around the bushing. Since the chains are needed to be resistant to corrosion and wear, they are often formed of stainless steel.

The pair of chains are looped over a plurality of gears called sprockets (sprocket wheels), and the teeth of the sprockets mesh with the bushings, such as described in Japanese Unexamined Utility Model Registration Application No. 4-64644, or the rollers of the chains. Accordingly, as the sprockets rotate, the chains move and the flights attached to the chains collect sand, sludge and the like.

On the other hand, the sprocket consists of a disc-shaped body and teeth disposed around the perimeter of the body, the teeth normally being more quickly worn than the body due to contact with the bushings.

For this reason, a sprocket of a known type is used of which teeth are replaceable, as described in Japanese Unexamined Patent Application Publication No. 3-172660, and fixed to the body by using bolts or other tightening means.

In the case of the structure described in Japanese Unexamined Utility Model Registration Application No. 4-64644, however, chains and sprockets are often formed of metallic materials of different types. A problem with this structure is that the contact of the chain and the sprocket causes corrosion due to a potential difference between the metallic materials when used for a water treatment apparatus.

Furthermore, there has also been a problem that because most structural members of the chain are formed of metallic materials, corrosion due to a potential difference between metallic materials of different types could occur through contacts thereof and result in shortening the life of the chain. Additionally, the metallic materials used for most structural members of the chain have caused a weight increase.

Such a sprocket having replaceable teeth as described in Japanese Unexamined Patent Application Publication No. 3-172660 is also often composed of a body, teeth and bolts, formed of metallic materials of different types. As a result, a problem has arisen that corrosion due to a potential difference between each of the structural members occurs when sprockets of this type are used for a water treatment apparatus.

### SUMMARY OF THE INVENTION

The present invention addresses the above problem with the object to provide a chain-sprocket mechanism, a chain and a sprocket which are highly resistant to corrosion.

In order to attain the above object, a first aspect of the invention provides a chain-sprocket mechanism that consists of a plurality of disc-shaped sprockets, having teeth disposed around the perimeter and rotatably mounted, and a chain provided so as to mesh with the teeth of the sprockets, the chain moving according to the rotation of the sprockets. The chain is structured by coupling a plurality of link plates that consist of a pair of outer plates provided so as to oppose each other, a pair of inner plates disposed inside the outer plates, a cylindrical bushing, fitted to the inner plates, having contact with the teeth, and a pin inserted through the outer plates, the inner plates and the bushing. The chain-sprocket mechanism is characterized in that the surface of at least either of the teeth and the bushing is formed of a non-metallic material.

The above non-metallic material may be either of ceramic or plastic. The plastic may be nylon, polyacetal, polyester, and ultrahigh-molecular-weight polyethylene, and also may include an additive. The surface of the inner and outer plates may be formed of the non-metallic material. The chain may further include rollers provided around the each bushing; the rollers may be formed of the non-metallic material.

A second aspect of the invention provides a chain-sprocket mechanism that also consists of a plurality of disc-shaped sprockets, having a plurality of teeth disposed around the perimeter and rotatably mounted, and a chain provided so as to mesh with the teeth of the sprockets, the chain moving according to the rotation of the sprockets. The chain is structured by coupling a plurality of link plates that consist of a pair of outer plates opposing each other, a pair of inner plates disposed inside the outer plates, a cylindrical bushing, fitted to the inner plates, having contact with the teeth, and a pin inserted through the outer plates, the inner plates and the bushing. The chain-sprocket mechanism is characterized by that the surfaces of the teeth and the bushings are formed of a metallic material common to the both members.

The above metallic material may be stainless steel. The surfaces of the inner and outer plates may be formed of the above metallic material. The chain may further include cylindrical rollers provided around the each bushing; the rollers may also be formed of the above metallic material.

A third aspect of the invention provides a chain that consists of pairs of stepped plates, which is composed of have an outer plate portion having a pin insert hole at its end and an inner portion having a bushing fitting hole at its end, bushings fitted in the bushing fitting holes, and pins inserted through the pin insert holes and the bushing. The chain is characterized by that the bushing is formed of plastic, and that the bushing has a notched portion on its both ends and the bushing fitting holes have a shape corresponding to the shape of the bushing ends.

The outer plate portions of the pairs of stepped plates should be oriented toward the direction of the chain travel. The plastic may be polyacetal, nylon, or ultrahigh-molecular-weight polyethylene. The stepped plate and the pin are formed of stainless steel common to both the members.

A fourth aspect of the invention provides a sprocket that consists of a disc-shaped body, tooth members replaceably disposed around the perimeter of the body, and bolts for fixing the tooth members to the body. The sprocket is characterized by that the surfaces of at least two members of the body, the teeth and the bolts are formed of a non-metallic material. The nonmetallic material may be either of ceramic or plastic; the plastic may be nylon, polyacetal, polyester, or ultrahigh-molecular-weight polyethylene, and also may include an additive.

A fifth aspect of the invention provides a sprocket that consists of a disc-shaped body, tooth members replaceably disposed around the perimeter of the body, and bolts fixing the tooth members to the body. The sprocket is characterized by that the surfaces of the body, the tooth members and the bolts are formed of a metallic material common to all the members. The metallic material may be stainless steel.

A sixth aspect of the invention provides a sprocket that consists of a disc-shaped body, tooth members replaceably disposed around the perimeter of the body, and bolts for fixing the tooth members to the body. The sprocket is characterized by that the surfaces of any two members of the body, the tooth members and the bolts are formed of a metallic material common to the two members, and the surface of the remaining member is formed of a non-metallic material. The metallic material may be stainless steel, and the non-metallic material may be either of ceramic or plastic. The plastic may be nylon, polyacetal, polyester, or ultrahigh-molecular-weight polyethylene, and also may include an additive.

The present invention can provide a chain-sprocket mechanism, a chain and a sprocket which are highly resistant to corrosion.

### BRIEF DESCRIPTION OF THE DRAWINGS

FIG. 1 is a perspective view showing a sludge collector.

FIG. 2 is a side sectional view of the sludge collector shown in FIG. 1.

FIG. 3 is a magnified drawing of a sprocket and its periphery.

FIG. 4 is a detailed drawing showing structural members of a chain.

FIG. 5 shows a chain having a configuration modified from the chain shown in FIG. 4.

FIG. 6 shows a chain having a configuration modified from the chain shown in FIG. 4.

FIG. 7 is a detailed drawing of the chain according to the second embodiment of the present invention.

FIG. 8 is a detailed drawing of link plates included in the chain shown in FIG. 7.

FIG. 9 is a magnified drawing showing the mesh of the chain shown in FIG. 7 and a sprocket.

FIG. 10 is a magnified drawing showing the mesh of the chain shown in FIG. 7 and a sprocket.

FIG. 11 is a magnified drawing of the sprocket according to the third embodiment of the present invention.

FIG. 12 is a tooth member of the sprocket shown in FIG. 11.

FIG. 13 is a top view of the tooth member shown in FIG. 12.

FIG. 14 shows the attachment of the tooth member to a body of the sprocket shown in FIG. 11.

### DESCRIPTION OF THE PREFERRED EMBODIMENTS

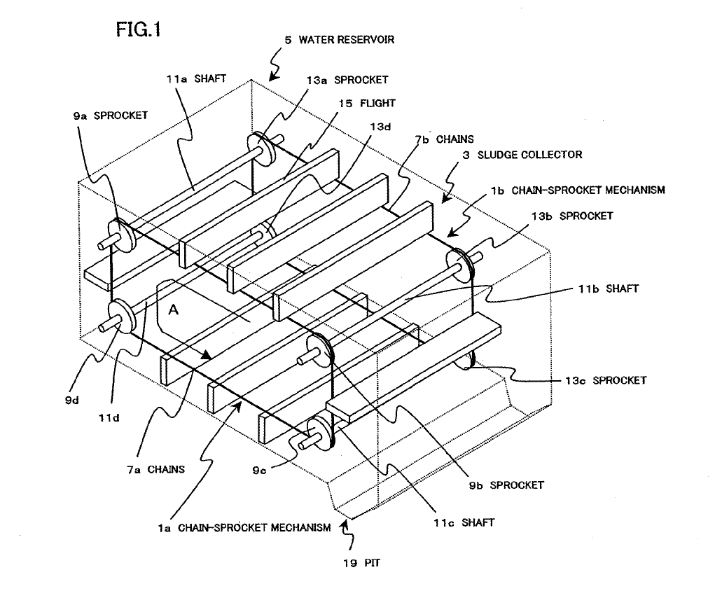

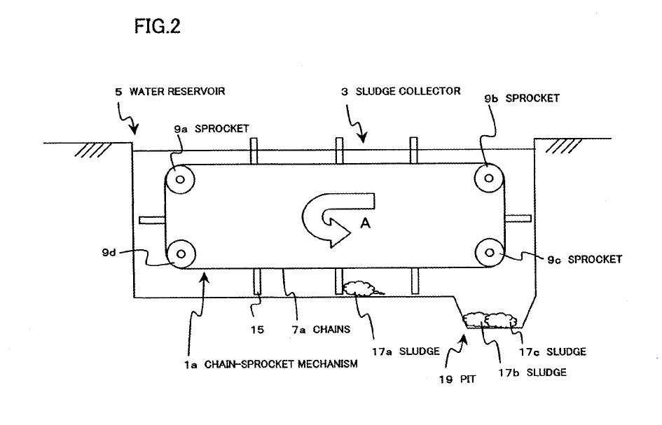

Preferred embodiments of the present invention will be described in detail with reference to the drawings below. FIG. 1 is a perspective view showing a sludge collector 3 including chain-sprocket mechanisms 1a, 1b, according to a first embodiment of the present invention, and FIG. 2 is a side sectional view of that shown in FIG. 1.

As shown in FIGS. 1 and 2, the sludge collector 3 is installed in a water reservoir 5 and includes a pair of chains 7a, 7b provided so as to oppose each other. The chain 7a and sprockets 9a, 9b, 9c, 9d constitute the chain-sprocket mechanism 1a, the chain 7a meshing with the sprockets 9a, 9b, 9c, 9d.

The sprockets 9a, 9b, 9c, 9d are respectively attached to shafts 11a, 11b, 11c, 11d supported at the side walls of the water reservoir 5. The chain 7a, therefore, rotates in the direction of the arrow A shown in FIG. 1 as the sprockets 9a, 9b, 9c, 9d rotate.

The chain 7b and sprockets 13a, 13b, 13c, 13d constitute the chain-sprocket mechanism 1b, the chain 7b meshing with the sprockets 13a, 13b, 13c, 13d.

The sprockets 13a, 13b, 13c, 13d are respectively attached to the shafts 11a, 11b, 11c, 11d supported at the side walls of the water reservoir 5. The chain 7b, therefore, rotates in the direction of the arrow A shown in FIG. 1 as the sprockets 13a, 13b, 13c, 13d rotate.

A plurality of long plate-shaped flights 15 are provided between the chains 7a, 7b; each of the edges of each of the plurality of flights 15 is connected to one of the chains 7a, 7b. The plurality of flights 15, therefore, rotates in the direction of the arrow A shown in FIG. 1 as the chains 7a, 7b rotate in the direction A.

Then sludges 17a, 17b, 17c precipitated on the bottom of the water reservoir 5 are collected by the rotating flights and discharged into a pit 19.

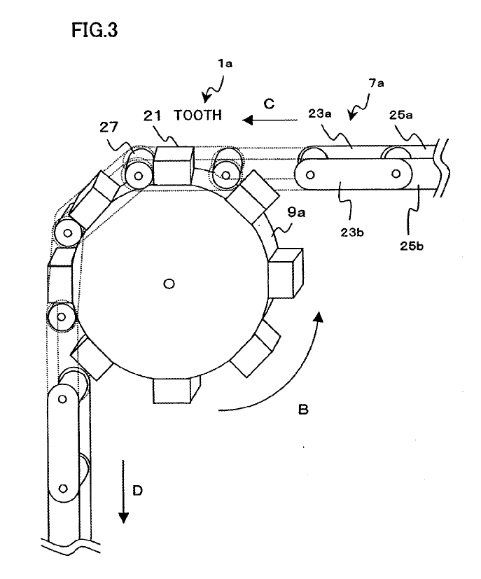

Next, a meshing mechanism between a sprocket and a chain will be described. FIG. 3 is a magnified drawing of the sprocket 9a and its periphery in FIG. 1. Note that descriptions of the meshing mechanisms between each of the sprockets 9b, 9c, 9d, 13a, 13b, 13c, 13d and the chain 7a or 7b are omitted since they are similar to the meshing mechanism between the sprocket 9a and the chain 7a.

As shown in FIG. 3, the sprocket 9a has a plurality of teeth 21 on its perimeter. The chain 7a includes pairs of flat-shaped outer plates 23a, 23b opposing each other, and pairs of inner plates 25a, 25b disposed inside the outer plates 23a, 23b.

Cylindrical bushings 27 are fitted to the inner plates 25a, 25b, and mesh with the teeth 21. Note that a detailed structure of the chain 7a will be described later.

As the sprocket 9a rotates in the direction B shown in FIG. 3, the teeth 21 propel the bushings 27 to move chain 7a in the direction C and then direction D.

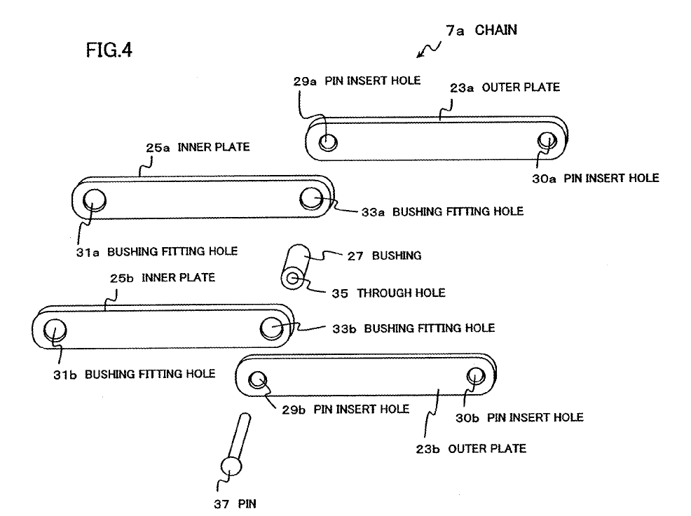

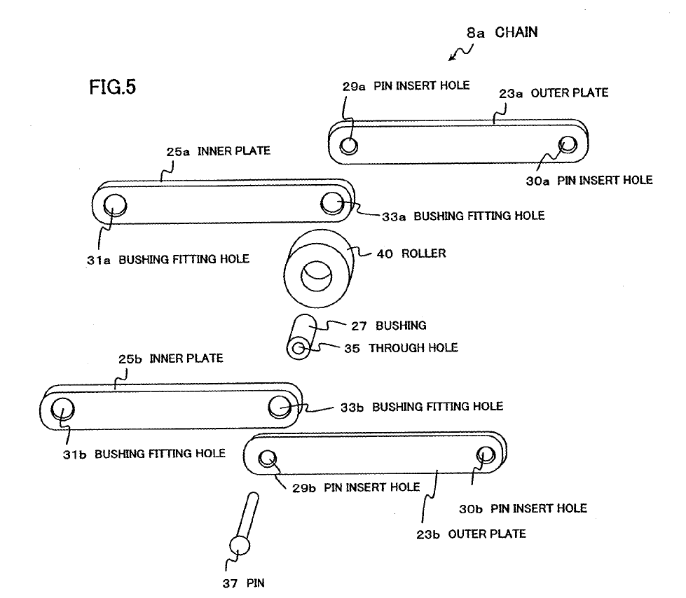

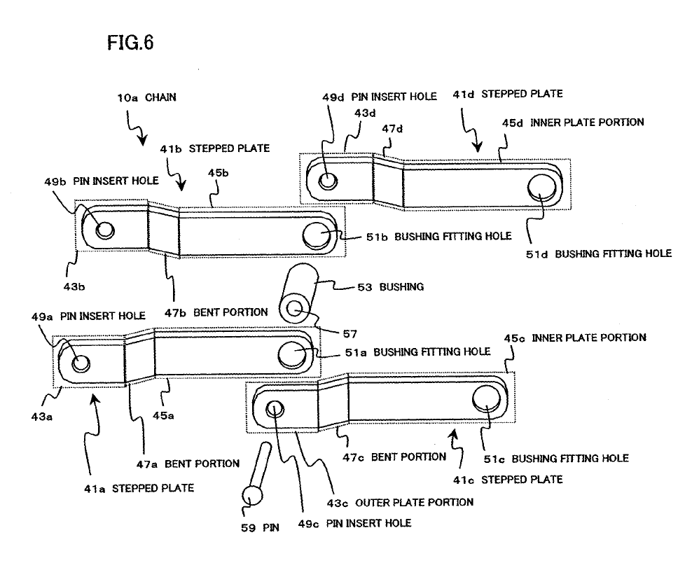

Next, a detailed description will be given of structural members of the chain 7a. FIG. 4 is a detailed drawing showing the structural members of the chain 7a, and FIGS. 5 and 6 are exemplary drawings showing chains having configurations modified from the chain 7a. Note that description of structural members of the chain 7b is omitted since they are similar to the structural members of the chain 7a.

As shown in FIG. 4, the chain 7a includes flat-shaped outer plates 23a, 23b opposing each other, the outer plates 23a, 23b having pin insert holes 29a, 30a, 29b, 30b at their both ends.

The chain 7a also includes flat-shaped inner plates 25a, 25b opposing each other, the inner plates 25a, 25b having bushing fitting holes 31a, 33a, 31b, 33b at both their ends.

Each of the ends of the cylindrical bushing 27 is fitted in one of the bushing fitting holes 33a, 33b.

A through hole 35 is provided in the middle of the bushing 27. A piece of the chain 7a is structured by inserting a rod-shaped pin 37 through the pin insert holes 29a, 29b of the outer plates 23a, 23b and the through hole 35 provided in the middle of the bushing 27. The outer plates 23a, 23b and the pin 37 constitute an outer link, and the inner plates 25a, 25b and the bushing 27 constitute an inner link.

Here, the surface of at least either of the bushing 27 or the teeth 21 of the sprocket 9a is formed of a non-metallic material. If a non-metallic material is used for the surface of either member as described above, corrosion caused by a potential difference does not occur through the contact between the bushing 27 and the teeth 21, and accordingly the corrosion resistance of the chain 7a and the sprocket 9a can be improved. Namely, the corrosion resistance of the chain-sprocket mechanism 1a can be improved. Note that description for the chain-sprocket mechanism 1b is omitted since the chain-sprocket mechanism 1b is similar to the chain-sprocket mechanism 1a.

The above non-metallic material includes, for example, ceramics, plastics, and the like.

The plastic is preferably highly resistant to wear, readily formable, and easily machinable. Such plastic materials may include polyacetal, nylon, polyester, UHMW-PE (ultrahigh-molecular-weight polyethylene) and the like.

A plastic reinforced with glass fibers may also be available as a material for the above use. By using these materials, wear resistance of the bushing 27 and/or the teeth 21 is improved considerably.

The entire bodies of the bushing 27 and the teeth 21 may be formed of a non-metallic material, however, it sufficient to only coat the contact surfaces of the bushing 27 and the teeth 21 with a non-metallic material.

Not only the surfaces of the bushing 27 and the teeth 21 but also the surfaces of the outer plates 23a, 23b and the inner plates 25a, 25b may be formed of a non-metallic material. With this configuration, corrosion caused by a potential difference does not occur through the contact between the outer plates 23a, 23b and the teeth 21, and also between the inner plates 25a, 25b and the teeth 21, which leads to a further improvement in the corrosion resistance of the chain 7a and the sprocket 9a.

There may be another configuration such that the surfaces of the bushing 27 of the chain 7a and the teeth 21 of the sprocket 9a are formed of a metallic material common to both the members. If such a metallic material is used for the surfaces of both the members, corrosion caused by a potential difference does not occur through the contact between the bushing 27 and the teeth 21, which also leads to an improvement in the corrosion resistance of the chain 7a and the sprocket 9a.

That is to say, the corrosion resistance of the chain-sprocket mechanism 1a can be improved. The same description can be given for the chain-sprocket mechanism 1b.

Here, the metallic material is preferably highly resistant to wear and corrosion. Stainless steel may be used as such a material.

Not only the surfaces of the bushing 27 and the teeth 21 but also the surfaces of the outer plates 23a, 23b and the inner plates 25a, 25b may be formed of a metallic material common to all the members. With this configuration, corrosion caused by a potential difference does not occur through the contact between the outer plates 23a, 23b and the teeth 21, and also between the inner plates 25a, 25b and the teeth 21, which leads to a further improvement in the corrosion resistance of the chain 7a and the sprocket 9a. That is to say, the corrosion resistance of the chain-sprocket mechanism 1a can be improved. The same description can be given for the chain-sprocket mechanism 1b.

A chain 8a shown in FIG. 5 may also be employed as a chain for the above use. The structure of the chain 8a is similar with that of the chain 7a except a cylindrical roller 40 is provided around the bushing 27.

In the case of using the chain 8a, the surface of the roller 40 is preferably formed of a non-metallic material since the roller 40 contacts the teeth 21. With this configuration, corrosion caused by a potential difference does not occur through the contact between the roller 40 and the teeth 21, which leads to an improvement in corrosion resistance of the chain 8a and the sprocket 9a. That is to say, the corrosion resistance of the chain-sprocket mechanism 1a can be improved.

The roller 40 and the teeth 21 may also be formed of a metallic material common to both members. With this configuration, corrosion caused by a potential difference does not occur through the contact between the roller 40 and the teeth 21, which leads to an improvement in corrosion resistance of the chain 8a and the sprocket 9a. That is to say, the corrosion resistance of the chain-sprocket mechanism 1a can be improved.

A chain 10a shown in FIG. 6 is another type of chain that may also be employed for the above use. The chain 10a is structured by using stepped plates that are formed so as to have an inner plate portion and an outer plate portion in one piece.

As shown in FIG. 6, the chain 10a has a structure in which stepped plates 41a and 41b oppose each other, and stepped plates 41c and 41d also oppose each other; the stepped plates 41a, 41b, 41c, 41d are configured so that the outer plate portions 43a, 43b, 43c, 43d and the inner plate portions 45a, 45b, 45c, 45d are joined via the bent portions 47a, 47b, 47c 47d respectively.

The outer plate portions 43a, 43b, 43c, 43d respectively have pin insert holes 49a, 49b, 49c, 49d at their ends, and the inner plate portions 45a, 45b, 45c, 45d respectively have bushing fitting holes 51a, 51b, 51c, 51d at their ends.

A cylindrical bushing 53 is fitted in the bushing fitting holes 51a, 51b. A through hole 57 is provided in the middle of the bushing 53. A piece of the chain 10a is structured by inserting a pin 59 through the pin insert holes 49c, 49d of the outer plate portions 43c, 43d and the through hole 57 provided in the middle of the bushing 53.

Also in the case of using the chain 10a structured as described above, if the surface of at least either of the bushing 53 or the teeth 21 is formed of a non-metallic material, corrosion caused by a potential difference does not occur through the contact between the bushing 53 and the teeth 21, and accordingly the corrosion resistance of the chain 10a and the sprocket 9a can be improved. Namely, the corrosion resistance of the chain-sprocket mechanism 1a can be improved.

Not only the surfaces of the bushing 53 and the teeth 21 but also the surfaces of the stepped plates 41a, 41b, 41c, 41d may be formed of a non-metallic material. With this configuration, corrosion caused by a potential difference does not occur through the contact between the stepped plates 41a, 41b, 41c, 41d and the teeth 21, which leads to a further improvement in the corrosion resistance of the chain 10a and the sprocket 9a. That is to say, the corrosion resistance of the chain-sprocket mechanism 1a can be improved.

The bushing 53 and the teeth 21 may also be formed of a metallic material common to both members. With this configuration, corrosion caused by a potential difference does not occur through the contact between the bushing 53 and the teeth 21, which leads to an improvement in the corrosion resistance of the chain 10a and the sprocket 9a. That is to say, the corrosion resistance of the chain-sprocket mechanism 1a can be improved.

In the case that the bushing 53 and the teeth 21 are formed of a metallic material common to both the members, the surfaces of the stepped plates 41a, 41b, 41c, 41d may also be formed of the metallic material. With this configuration, corrosion caused by a potential difference does not occur through the contact between the stepped plates 41a, 41b, 41c, 41d and the teeth 21, which leads to an improvement in the corrosion resistance of the chain 10a and the sprocket 9a. That is to say, the corrosion resistance of the chain-sprocket mechanism 1a can be improved.

A cylindrical roller may be provided around the bushing 53 of the chain 10a. In the case of providing the roller, if the surface of the roller is formed of a non-metallic material, corrosion caused by a potential difference does not occur through the contact between the roller and the teeth 21, and accordingly the corrosion resistance of the chain 10a and the sprocket 9a can be improved. Namely, the corrosion resistance of the chain-sprocket mechanism 1a can be improved.

The roller and the teeth 21 may also be formed of a metallic material common to both members. With this configuration, corrosion caused by a potential difference does not occur through the contact between the roller and the teeth 21, which leads to an improvement in the corrosion resistance of the chain 10a and the sprocket 9a. Namely, the corrosion resistance of the chain-sprocket mechanism 1a can be improved.

According to the first embodiment of the present invention, as described above, the chain-sprocket mechanisms 1a, 1b include chains and sprockets, and the surface of at least either of the bushings 27 of the chains and the teeth 21 of the sprockets is formed of a non-metallic material. Accordingly, corrosion caused by a potential difference between the chains and sprockets can be prevented, and the corrosion resistance of the chain-sprocket mechanisms 1a and 1b is improved.

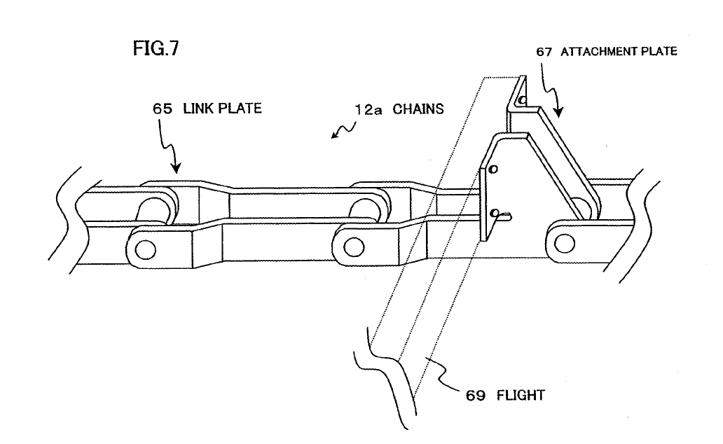

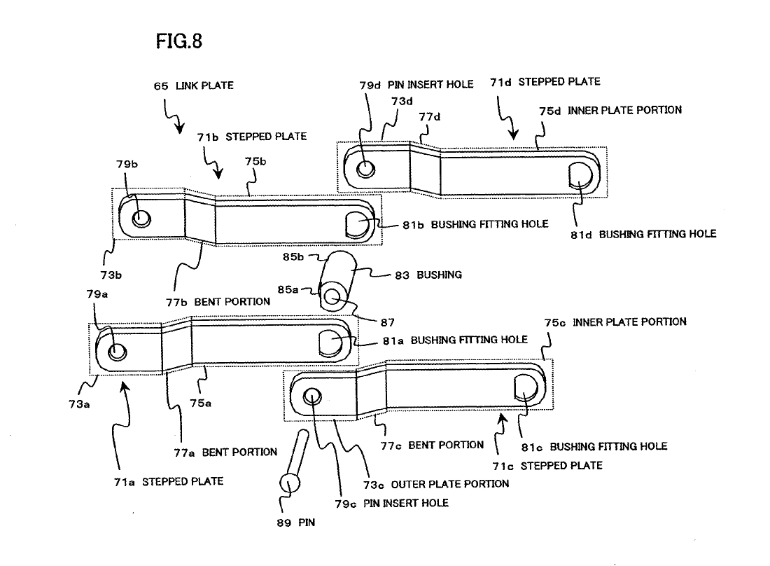

Next, a second embodiment of the present invention will be described below. FIG. 7 is a detailed drawing of a chain 12a used for sludge collector 4 according to the second embodiment, and FIG. 8 is a detailed drawing of link plates 65 included in the chain 12a.

Note that description of the structure of the sludge collector 4 is omitted since the structure is similar to that structure of the sludge collector 3 according to the first embodiment. Also note that attachment plates 67 are not shown in FIG. 8.

As shown in FIG. 7, the chain 12a is structured by coupling a plurality of link plates 65. The attachment plates 67 are provided every certain link plates 65, and a plurality of flights 69 are respectively attached to the attachment plates 67.

As shown in FIG. 8, the link plate 65 consists of stepped plates 71a, 71b opposing each other, and outer plate portions of the stepped plates 71c, 71d are connected to the outside of inner plate portions of the stepped plates 71a, 71b.

The stepped plate 71a has the outer plate portion 73a, the inner plate portion 75a and a bent portion 77a that is provided between the outer plate portion 73a and the inner plate portion 75a.

The stepped plate 71b has the outer plate portion 73b, the inner plate portion 75b and a bent portion 77b that is provided between the outer plate portion 73b and the inner plate portion 75b.

Namely, the link plate 65 is such that the space between the outer plate portions 73a and 73b is larger than that of the inner plate portions 75a and 75b.

The outer plate portion 73a of the stepped plate 71a has a pin insert hole 79a at its end, and the inner plate portion 75a has a bushing fitting hole 81a at its end. The outer plate portion 73b of the stepped plate 71b has a pin insert hole 79b at its end, and the inner plate portion 75b has a bushing fitting hole 81b at its end.

The structures of stepped plates 71c, 71d, are similar to the structures of the stepped plates 71a, 71b. Namely, the stepped plates 71c, 71d have outer plate portions 73c, 73d, inner plate portions 75c, 75d, and bent portions 77c, 77d that are respectively provided between the outer plate portions 73c, 73d and the inner plate portions 75c, 75d.

The outer plate portions 73c, 73d respectively have pin insert holes 79c, 79d at their ends, and the inner plate portions 75c, 75d respectively have bushing fitting holes 81c, 81d at their ends.

Both ends of a bushing 83 are fitted in the bushing fitting holes 81a, 81b. A through hole 87 is provided in the middle of the bushing 83. A piece of the chain 12a is structured by inserting a pin 89 through the pin insert holes 79c, 79d of the outer plate portions 73c, 73d and the through hole 87 provided in the middle of the bushing 83.

Here, the bushing 83 is formed of plastic, while the stepped plates 71a, 71b, 71c, 71d and the pin 89 are formed of stainless steel common to all the members.

By using plastic to form the bushing 83, corrosion caused by a potential difference does not occur through the contact of the bushing 83 with the stepped plates 71a, 71b, 71c, 71d, the pin 89 and teeth 93 of a sprocket 91 (described later), which leads to an improvement in the corrosion resistance of the chain 12a.

The plastic is preferably highly resistant to wear, readily formable, and easily machinable. Such plastic materials may include polyacetal, nylon, polyester, UHMW-PE (ultrahigh-molecular-weight polyethylene) and the like, among which the polyacetal is most preferable.

A plastic bushing fitted to the stepped plates 71a, 71b may rotate in the holes because it is not firmly held due to the elasticity of plastic material. For this reason, as shown in FIG. 8, notched portions 85a, 85b are provided for the bushing 83, and the bushing fitting holes 81a, 81b have a shape corresponding to the notched portions 85a, 85b.

Accordingly, even though the bushing 83 is forced to rotate, the notched portions 85a, 85b united with the stepped plates 71a, 71b prevent the bushing 83 from being rotated.

Since the stepped plates 71a, 71b, 71c, 71d, and the pin 89 are formed of stainless steel common to all the members, a potential difference does not arise when these members contact each other. Therefore, corrosion caused by a potential difference can be prevented, which leads to an improvement in the corrosion resistance of the chain 12a.

In the case of using the chain 12a, the stepped plates 71a, 71b, 71c, 71d are preferably oriented so that the outer plate portions 73a, 73b, 73c, 73d are ahead of the inner plate portions 75a, 75b, 75c, 75d in the direction in which the chain 12a travels.

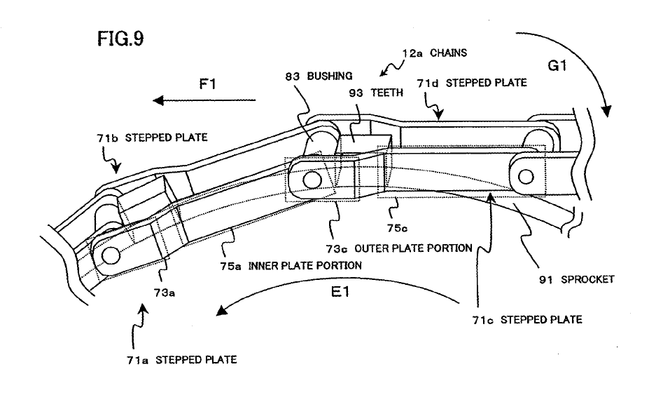

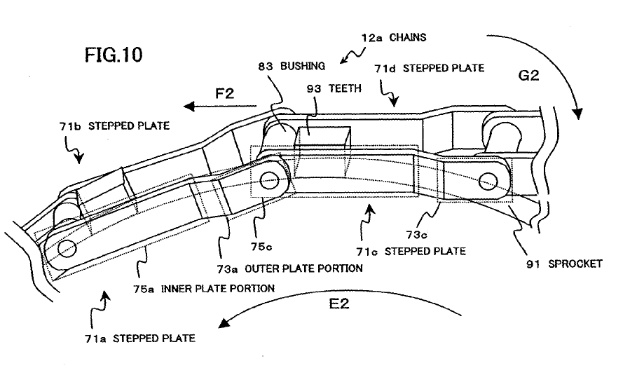

FIGS. 9 and 10 are magnified drawings showing the mesh of the chain 12a and sprocket 91.

In FIG. 9, the stepped plates 71a, 71c are oriented so that the outer plate portions 73a, 73c are ahead of the inner plate portions 75a, 75c in the direction F1 in which the chain 12a travels.

In this case, when the sprocket 91 rotates in the direction E1, the chain is driven in the direction F1 by the teeth 93 meshing with the bushings 83, which allows the stepped plates 71c, 71d to rotate in the direction G1 and to move along the perimeter of the sprocket 91.

Then, although the stepped plates 71c, 71d rotate in the direction G1, the bushings 83 do not rotate because they are fitted to the stepped plates 71a, 71b, which means that sliding due to the rotation of bushings 83 does not occur between the bushings 83 and the teeth 93, and thereby the both members do not get worn.

On the other hand, in FIG. 10, the stepped plates 71a, 71c are oriented so that the outer plate portions 73a, 73c are in the rear of the inner plate portions 75a, 75c in the direction F2 in which the chain 12a travels.

Also in this case, when the sprocket 91 rotates in the direction E2, the chain is driven by the teeth 93 meshing with the bushings 83 in the direction F2, which allows the stepped plates 71c, 71d to rotate in the direction G2 and to move along the perimeter of the sprocket 91.

Then, as the stepped plates 71c, 71d rotate in the direction G2, the bushings 83 also rotate in the direction G2 together with the stepped plates 71c, 71d because the bushings 83 are fitted to the stepped plates 71c, 71d, which means that sliding due to the rotation of bushings 83 occurs between the bushings 83 and the teeth 93, and thereby the both members get worn.

For this reason, in order to minimize the wear of the chain 12a, it is preferable to use the chain 12a by orienting the stepped plates 71a, 71b, 71c, 71d so that the outer plate portions 73a, 73b, 73c, 73d are ahead of the inner plate portions 75a, 75b, 75c, 75d in the direction in which the chain 12a travels.

According to the second embodiment of the present invention, as described above, the chain 12a includes the stepped plates 71a, 71b, 71c, 71d and the bushings 83, and the bushing 83 is formed of a plastic material. Accordingly, corrosion caused by a potential difference between the bushing 83 and the other members can be prevented, and the corrosion resistance of the chain 12a is improved.

Also according to the second embodiment, the notched portions 85a, 85b are provided at both ends of the bushing 83, and the bushing fitting holes 81a, 81b have a shape corresponding to the notched portions 85a, 85b. Consequently, it is prevented for the bushing 83 to rotate by itself even though the bushing 83 is formed of a plastic material.

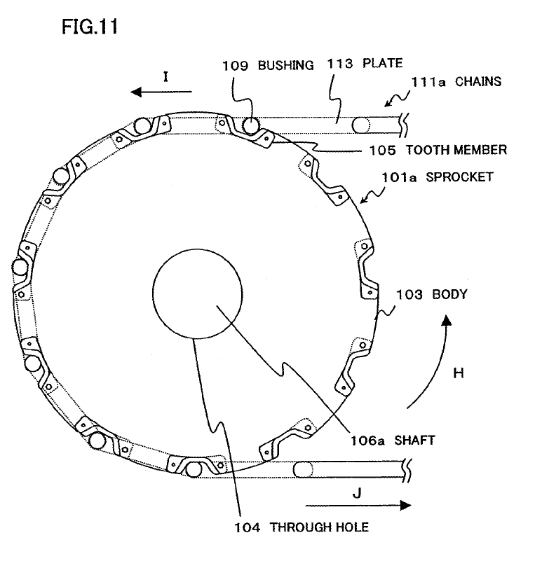

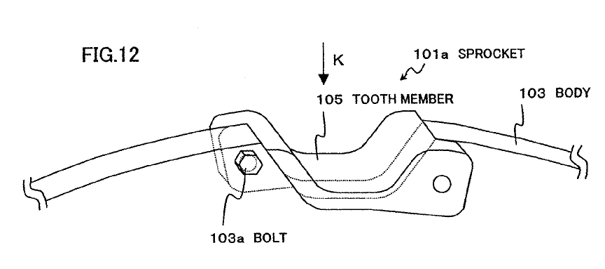

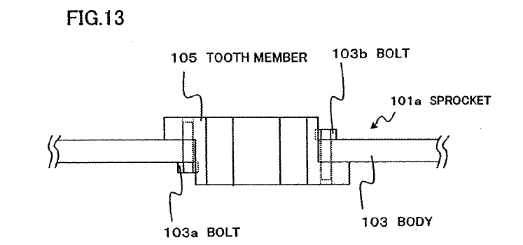

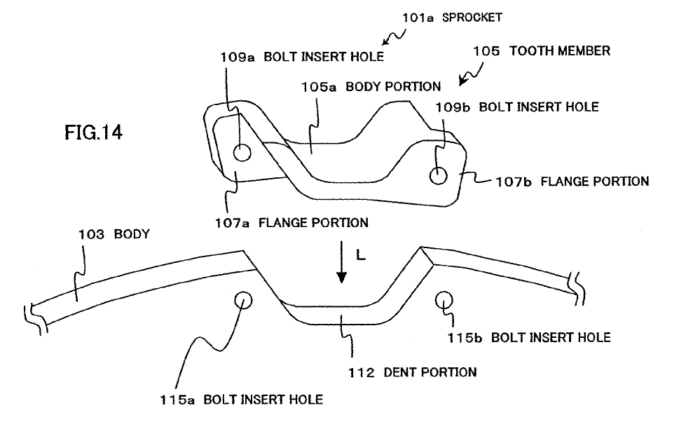

Next, a third embodiment of the present invention will be described below. FIG. 11 is a magnified drawing of a sprocket 101a used for the sludge collector 4a according to the third embodiment, and FIG. 12 is a magnified drawing of a tooth member 105 and its periphery. Further, FIG. 13 shows a view from the direction of the arrow K in FIG. 12, and FIG. 14 is an explanatory drawing showing how the tooth member 105 is attached to a body 103.

Note that description of the structure of the sludge collector 4a is omitted since the structure is similar to that structure of the sludge collector 3 according to the first embodiment.

As shown in FIG. 11, the sprocket 101a has a plurality of tooth members 105 fixed on the perimeter of the disc-shaped body 103, and a shaft 106a is inserted into a through hole 104 provided substantially in the center of the body 103. A chain 111a includes flat-shaped plates 113 opposing each other.

Cylindrical bushings 109 are fitted to the plates 113, and mesh with the tooth members 105.

As the sprocket 101a rotates in the direction H shown in FIG. 11, the tooth members 105 propel the bushings 109, which allows the chain 111a to moves in the direction I and then the direction J.

As shown in FIGS. 12 and 13, the tooth member 105 is fastened to the body 103 by using bolts 103a, 103b, i.e., the tooth members 105 are provided on the perimeter of the body 103 so as to be replaceable. The sprocket 101a consists of three structural members: the body 103, the tooth members 105 and the bolts 103a, 103b, which are in contact with each other.

As shown in FIG. 14, the tooth member 105 consists of a concave-shaped body portion 105a and flange portions 107a, 107b provided at both sides of the body portion 105a, and bolt insert holes 109a, 109b are provided at the flange portions 107a, 107b, the bolt insert holes 109a, 109b having female threads (not shown) on the inner peripheries thereof.

The body 103 has dent portions 112 of which the shape conforms to that of the body portion 105a of the tooth member 105, and bolt insert holes 115a, 115b are provided near each of the dent portions 112.

The tooth member 105 is attached to the body in such a manner that the tooth member 105 is moved in the direction L as shown in FIG. 14 to be fitted to the dent portion 112, and then the bolt 103a is inserted into the bolt insert holes 109a and 115a to be tightened for fixing the tooth member 105 to the body 103.

The bolt 103b is also inserted into the bolt insert holes 109b and 115b to be tightened for fixing the tooth member 105 to the body 103.

When it is necessary to replace the tooth member 105 by reason of wear or the like, the bolts 103a, 103b are removed, and the tooth member 105 is detached from the body 103.

The sprocket 101a consists of the body 103, the tooth members 105 and the bolts 103a, 103b; the surfaces of at least two of the three structural members are formed of a non-metallic material.

If the surface materials of at least two structural members are non-metallic, the contact of the structural members composing the sprocket 101a occurs either between non-metallic materials or between a non-metallic material and a metallic material.

Accordingly, regardless of whichever of the body 103, the tooth members 105 and the bolts 103a, 103b contact each other, corrosion caused by a potential difference does not occur, and the corrosion resistance of the sprocket 101a can be improved. All the members composing the sprocket 101a may also be formed of a non-metallic material.

Here, the non-metallic materials include, for example, plastics, ceramics, and the like.

The plastics are preferably highly resistant to wear, readily formable, and easily machinable. Such plastic materials may include polyacetal, nylon, polyester, UHMW-PE (ultrahigh-molecular-weight polyethylene) and the like.

A plastic reinforced with glass fibers may also be available as a material for the above use. By using these materials, the wear resistance of the sprocket 101a is improved considerably.

The entire bodies of the body 103, the tooth members 105 and the bolts 103a, 103b may be formed of a non-metallic material, however, it is sufficient to only coat the contact surfaces of the body 103, the tooth members 105 and the bolts 103a, 103b with a non-metallic material.

The surfaces of the body 103, the tooth members 105 and the bolts 103a, 103b may also be formed of a metallic material common to all the members. If the surfaces of these structural members are formed of a metallic material common to all the members, these structural members always contact each other at surfaces formed of the metallic material.

Accordingly, corrosion caused by a potential difference does not occur through the contact of one of the structural members with the other, which leads to an improvement in the corrosion resistance of the sprocket 101a.

Here, the metallic material is preferably highly resistant to wear and corrosion. Stainless steel may be used as such a material.

Furthermore, it is also preferable that the surface of one of the three structural members is formed of a non-metallic material and the surfaces of the remaining members are formed of a metallic material common to both the members. If the surface materials of these structural members are formed in such a manner, the contact either between metallic materials common to both of the members or between a non-metallic material and a metallic material occurs among the structural members.

Accordingly, corrosion caused by a potential difference does not occur through the contact of one of the structural members with the other, which leads to an improvement in the corrosion resistance of the sprocket 101a.

According to the third embodiment of the present invention, as described above, the sprocket 101a consists of three structural members: the body 103, the tooth members 105 and the bolts 103a, 103b, and the surface material of at least two of the structural members is non-metallic. The corrosion resistance of the sprocket 101a can thereby be improved.

While preferred embodiments of the present invention have been described above with reference to the accompanying drawings, the scope of the present invention is not affected by the embodiments specified in the above description. It will be apparent that a person skilled in the art may make an alteration or a modification within the technological scope disclosed in the claims; consequently, it is understood that any of such altered or modified inventions will fall in the scope of the present invention.

What is claimed is:

1. A chain comprising:
pairs of stepped plates,
wherein the outer plate portion has a pin insert hole at its end and the inner plate portion has a bushing fitting hole at its end;
bushings fitted in the bushing fitting holes; and
pins inserted through the pin insert holes and the bushing,
wherein the bushing is formed of a plastic material, having a notch at both ends, and the bushing fitting holes have a shape corresponding to the shape of the bushing ends.

2. The chain according to claim 1,
wherein the outer plate portions of the stepped plates are oriented in the traveling direction of the chain.

3. The chain according to claim 1,
wherein the plastic material is nylon, polyacetal, polyester, or ultrahigh-molecular-weight polyethylene.

4. The chain according to claim 1,
wherein the stepped plate and the pin are formed of stainless steel common to both members.
